(19) United States
(12) Patent Application Publication
(10) Pub. No.: US 2013/0274931 A1
(43) Pub. Date: Oct. 17, 2013

(54) SHAPE ADJUSTMENT SYSTEM USING LASER PEENING

(71) Applicant: APPLE INC., Cupertino, CA (US)

(72) Inventors: Shravan BHARADWAJ, Palo Alto, CA (US); David I. MORGENSTERN, San Jose, CA (US)

(73) Assignee: APPLE INC., Cupertino, CA (US)

(21) Appl. No.: 13/623,034

(22) Filed: Sep. 19, 2012

Related U.S. Application Data
(60) Provisional application No. 61/624,836, filed on Apr. 16, 2012.

(51) Int. Cl. G01B 5/02

(52) U.S. Cl. 700/279

(57) ABSTRACT

Systems which may be employed to adjust the shape of computer housing are provided. The systems may include a measurement apparatus that measures the positions of points on the housing. A determining apparatus may determine an offset between the position of the points and reference values. An adjustment apparatus may apply a laser to the computer housing having parameters based on the offset at each of the points. The adjustment apparatus can rely upon a laser beam that impinges on the surface of the computer housing causing a shock wave that, in turn, creates a force that elastically deforms the computer housing. This process may be repeated or otherwise continued until the offset is within a predetermined range of acceptable values.

### CROSS-REFERENCE TO RELATED APPLICATIONS

This application claims priority under 35 U.S.C. 119(e) to U.S. Provisional Patent Application No. 61/624,836, filed Apr. 16, 2012, and entitled “SHAPE ADJUSTMENT SYSTEM USING LASER PEENING”, which is incorporated herein by reference in its entirety and for all purposes.

### TECHNICAL FIELD

The present disclosure relates generally to methods and systems for adjusting the shape of items, and more particularly to methods and systems for adjusting the shape of computer housing such that it properly mates with a display cover.

### BACKGROUND

Sophisticated computers, terminals, televisions, and other devices that utilize display screens are developing at a rapid rate. In such competitive markets with many brands and providers, there is an ever-present demand for improved and/or distinguished appearances, functionalities, and aesthetics in the newest computers and other similar devices. One area that continually receives great attention for improved and distinguished appearances in such devices involves visual outputs, which can include display screens, lights and other variable visual indicators. As consumer products grow more complex with greater capabilities, and with so many providers and competing products to choose from, however, it becomes increasingly difficult to provide products having display screens that are distinguished and eye-catching, yet uncluttered and aesthetically pleasing.

For example, significant strides have been made in recent years with respect to display screens for laptop computers. Newer technologies have resulted in laptop computer makers being able to mass produce display screens that are clearer, thinner and larger in area, while producing less heat than in earlier models. In addition, the materials used to house and support laptop display screens, typically in one half of a clamshell type arrangement, have become stronger and arranged better in recent years. This enables the ability to use less plastic or other material to support and “frame” the display screen, which can then result in more area dedicated to the display screen itself and a more aesthetic display appearance.

Another more particular example of a distinguished and aesthetically pleasing large display screen presentation can be found with respect to the iMac® personal computer made by Apple Inc. of Cupertino, Calif. In this display presentation, a large display screen is secured within a computer housing having a back, bottom, relatively thin sides and top, and a large opening in the front that comprises over 75% of the frontal area. A display cover glass is positioned into and held in place in a set back recess in the frontal opening area of the computer housing specifically designed to secure the cover glass, such that the display screen is visible there through. An inked mask around the display cover glass edge, rounded housing corners and a metallic finish augment the overall appearance. The end result is an aesthetically pleasing look dominated by a relatively large display screen that is visible to the user through a display cover glass and positioned within a computer housing that does not require substantially more height or width than the display screen itself.

While many designs and techniques used to present a display screen have generally worked well in the past, there is always a desire to improve on the accuracy of the assembly thereof, such that improved functionality and/or appearance is provided.

### SUMMARY

The present disclosure provides systems and related methods and computer code for adjusting the shape of an item such as computer housing. For example, in an assembled computer, cover glass may be coupled to the computer housing and hence the shape and dimensions of the computer housing may affect the interface therebetween. By way of further example, light leakage may occur at edges of the computer housing between the computer housing and the cover glass if the dimensions and shape of the computer housing differ from the specifications.

A method for adjusting a shape of a computer housing is described. The method is carried out by measuring a position of a plurality of points on a portion of the computer housing, determining an offset between the position and a reference value for each of the points, and comparing the offset at each of the points to a range of offset values corresponding to each point, and using a laser to apply a force only at those points having offset values outside of the range of offset values for an amount of time. It should be noted that measuring the position, determining the offset, and applying the force are conducted until the offset is within a predetermined range of acceptable values. Moreover, the method teaches repeating the comparing and using the laser until substantially all offsets are within their respective ranges of offset values.

In another embodiment, the systems may include a measurement apparatus that measures the position of points on the computer housing. By comparing the positions of the points to reference values, a determining apparatus may determine an offset there-between. Once the offsets are known, an adjustment apparatus may apply force to the computer housing (or other item) based on the offsets. This may occur (e.g., concurrently or sequentially) until the offset at each of the points falls within a predetermined range of acceptable values. Accordingly, the shape of the computer housing (or other item) may be adjusted to meet the desired specifications. In the described embodiment, the adjustment apparatus can rely upon directed energy to apply the shaping force. The directed energy can take the form of collimated photons of a laser applied to the surface of the computer housing. After an initial laser shaping operation, also referred to as laser peening, the measurement apparatus re-measures the position of points on the computer housing and determines any offsets that are greater than a pre-determined threshold. The laser peening operation is then performed at those points on the surface having an offset greater than the predetermined value.

In yet another embodiment, non-transitory computer readable medium for storing computer code executable by a processor for adjusting a shape of a computer housing is described. In one embodiment, the computer readable includes computer code for: measuring a position of a plurality of points on a portion of the computer housing, determining an offset between the position and a reference value for each of the points, comparing the offset at each of the points to a range of offset values corresponding to each point, using a laser to apply a force only at those points having offset values outside of the range of offset values for an amount of time, wherein measuring the position, determining the offset, and applying the force are conducted until the offset is within a predetermined range of acceptable values, and repeating the comparing and using the laser until substantially all offsets are within their respective ranges of offset values.

A method of modifying a shape of an enclosure is also disclosed. The method is carried out by obtaining a set of measured values at selected points of the enclosure, obtaining a set of offset values at at least some of the selected points based upon the set of measured values, adjusting a parameters of a laser in accordance with the set of offset values, obtaining a set of mechanical pre-stress characteristics used to pre-stress the enclosure at selected pre-stress points, and modifying the shape of the enclosure by applying a mechanical stress at the selected pre-stress points in accordance with the pre-stress characteristics, and applying the laser at pre-determined points in accordance with the laser parameters, wherein the modifying is carried out until most of the offset values are within a pre-determined range of acceptable offset values.

Other apparatuses, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed systems and methods for adjusting a display cover to computer housing interface for a personal computer or other device having a display screen. These drawings in no way limit any changes in form and detail that may be made to the disclosure by one skilled in the art without departing from the spirit and scope of the disclosure.

FIG. 1 illustrates a front view of a prior art computing device having a display screen that extends to distal edges of a computer housing according to one embodiment of the present disclosure;

FIG. 2 illustrates a side view of the computing device of FIG. 1;

FIG. 3 illustrates a perspective partially-exploded view of the computing device of FIG. 1;

FIGS. 4A and 4B illustrates representative systems configured to adjust a shape of a computer housing by employing a laser beam to contact a portion of the computer housing being adjusted according to an example embodiment of the present disclosure;

FIG. 5A illustrates representative laser beam prior to impinging on surface of workpiece;

FIG. 5B illustrates representative laser beam prior to impinging on surface of workpiece;

FIG. 6 shows representative offset value datum and range of acceptable offset values; and

FIG. 7 illustrates a flowchart of an example method for adjusting a shape of computer housing according to an example embodiment of the present disclosure.

### DETAILED DESCRIPTION

Exemplary applications of apparatuses and methods according to the present disclosure are described in this section. These examples are being provided solely to add context and aid in the understanding of the disclosure. It will thus be apparent to one skilled in the art that the present disclosure may be practiced without some or all of these specific details. In other instances, well known process steps have not been described in detail in order to avoid unnecessarily obscuring the present disclosure. Other applications are possible, such that the following examples should not be taken as limiting.

In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting; such that other embodiments may be used, and changes may be made without departing from the spirit and scope of the disclosure.

The disclosure relates in various embodiments to a display cover to housing interface system for a device having a visual display, and related systems and methods for adjusting the interface therebetween. Various types of displays that can be associated with such an interface system and associated device can include, for example, cathode ray tube (“CRT”), liquid crystal display (“LCD”), or plasma displays, as well as various light emitting diode (“LED”) arrangements or any other device used to present a visual display to a viewer. Associated devices having such a visual display and interface system can be, for example, a television, terminal, monitor or integrated computing device, among other possibilities that have display screens. One particular example of an integrated computing device can be an iMac® personal computer made by Apple Inc., as well as other similar integrated computing devices. Other possibilities that may utilize such an interface system can include various handheld media devices, such as the iPod® and iPhone® personal handheld media devices, also made by Apple Inc.

In various embodiments of the present disclosure a display cover is placed proximate to the viewing area of an associated display screen, which again can be any type of display screen used to present a visual display to a viewer. It will be readily appreciated that such a display cover can be separate from the display screen itself. In fact, such display covers are often used to provide additional protection and distance from the securely installed and specially treated glass or other substance that forms a front screen part of the CRT, LCD, plasma display or other display device. It will be readily appreciated that such a display cover may be separated from the display device itself, and that such a display cover may also be referred to as a cover glass, safety panel or other suitable designation. While such a display cover, cover glass or safety panel can typically be formed from glass, it will be understood that various types of plastics and/or other suitable transparent or translucent materials may alternatively be used to form the display cover or cover glass.

The systems may include a measurement apparatus that measures the position of points on the computer housing. The position points can be compared to a reference datum that includes a reference value for substantially all measured points. A determining apparatus can compare the measured values to the reference value for each point. By comparing the measured values of the points to reference values, a determining apparatus may determine an offset there-between. For those points having an offset value that is outside of a range of acceptable offset values, those points can be subjected to a corrective laser peening operation. In one embodiment, the laser characteristics can be determined based upon the amount of offset, the material that forms the housing, etc. In one embodiment, the housing can be pre-stressed in order to cause the housing in the vicinity of the points to be laser peened to be elastically deformed. In this way, the shape of the computer housing (or other item) may be adjusted to meet the desired specifications. In the described embodiment, the adjustment apparatus can rely upon directed energy to apply the shaping force. The directed energy can take the form of collimated photons of a laser applied to the surface of the computer housing that generate a shock wave that propagates into the housing, the shockwave causing a deformation in the housing. After an initial laser peening operation, the measurement apparatus re-measures the position of points on the computer housing and determines any offsets that are greater than a pre-determined threshold. The laser peening operation is then performed at those points on the surface having an offset greater than the predetermined value.

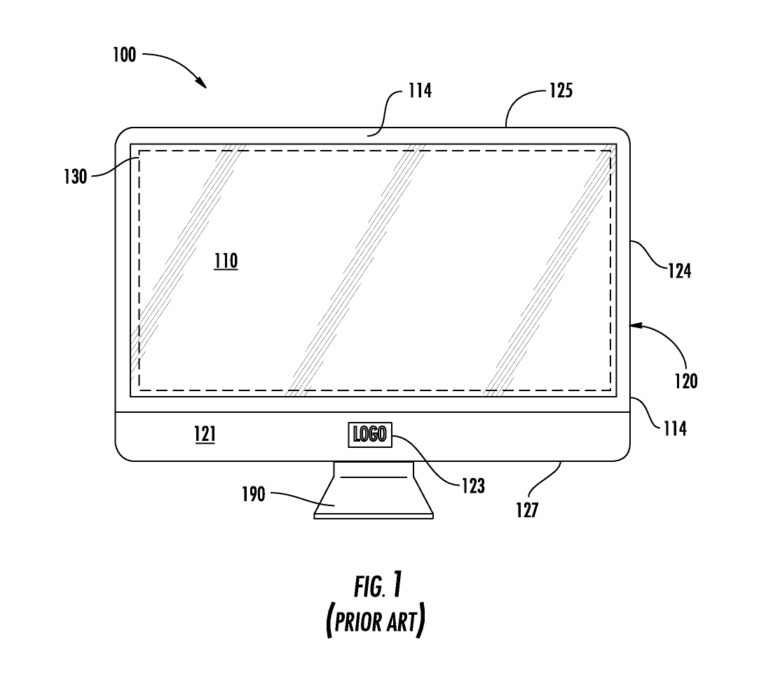

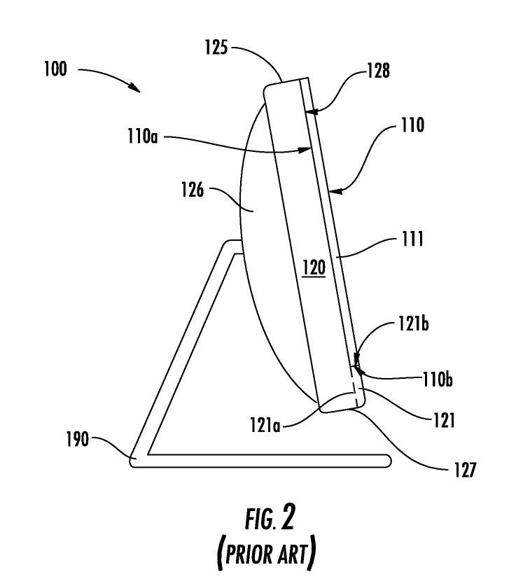

Referring first to FIGS. 1 and 2, an exemplary computing device having an oversized display screen presentation utilizing a display screen to housing interface according to one embodiment of the present disclosure is illustrated in front elevation and side elevation views respectively. Computing device 100 can be a desktop computer or associated monitor as shown, although various other devices having the distinctive display to housing interface disclosed herein may also be used. The computing device 100 can have a display cover 110 disposed with respect to an outer computer housing 120. Display cover 110 is preferably placed proximate to and in front of a display device 130 that is enclosed within computer housing 120. Computer housing 120 can also enclose various other computer components, such as a microprocessor (not shown) coupled to the display device 130, as well as one or more memory or storage units, speakers, additional displays or indicators, buttons or other input devices, video cards, sound cards, power inlets, various ports, and the like. Alternatively, the depicted computing device 100 may only include a monitor, terminal or other simple display unit, with any associated processors or other computing components being located away from the depicted display device.

A stand 190 or other similar structure can be used to support the entire computing device 100. Further, the computer housing 120 can have a frontally offset bottom chin portion or region referred to herein as a base member 121 that borders a bottom side edge of the display cover 110. The base member 121 can be entirely or substantially monochromatic, and may have a logo 123 or other contrasting symbol or display disposed thereupon. In addition, computer housing 120 can also have one or more side walls 124 and a top wall 125 that extend backwards from the front face of computing device 100, as well as a back wall 126 (see, e.g., FIG. 2). Such a back wall 126 may have some amount of curvature to it in various directions, and computer housing 120 may form a single integrated unit including base member 121, side walls 124, top wall 125, bottom wall 127, and back wall 126, as will be readily appreciated.

In another embodiment the base member 121 may be a separate component that is attached to the side walls 124 and bottom wall 127 along line 121a (see, FIG. 2) to the computer housing 120. In this regard, for example, the base member 121 may be welded (e.g., laser welded) to the computer housing 120 at the sidewalls 124 and the bottom wall 127. Accordingly, in one example embodiment, the base member 121 may be attached to the computer housing 120 by welding three edges of the base member to the computer housing.

The display cover 110 can be relatively thin in nature, and preferably has a front face that is exposed to the outside of computing device 100, an obverse face that is placed proximate to display device 130 and is thus inside of the computing device, and a distal edge portion 111 between the front and obverse faces and around an outer circumference of the display cover. This distal edge or edge portion 111 essentially reflects the thickness of the display cover 110 at its outer side or sides. Such a thickness of the edge portion at the outer edges can vary, and may even become zero at some locations, such as in the case of a sharp edge to the cover glass. Although various embodiments are certainly possible, it is specifically contemplated that the thickness of this outer edge portion remains substantially constant around the full circumference of the display cover 110.

As illustrated, the computer housing 120 of computing device 100 generally does not have any raised frame or side walls that surround and support the top or side edges of display cover 110. As such, the distal edge portion or portions 111 of the display cover 110 are visible and fully exposed to the outside of the computing device 100, such that a user viewing the computing device directly from the side or top can easily see the respective exposed side or top distal edge portions of the display cover. The result is a distinctive “apparently floating” display cover appearance for the display arrangement specifically, and the overall computing device in general, that is aesthetically pleasing while remaining fully functional with respect to display presentation capabilities.

While this “apparently floating” display cover arrangement may provide a distinguished yet elegant and aesthetically pleasing presentation with respect to many conventional display screen presentations, such an arrangement still requires adequate support in various pertinent directions for the display cover. Although gluing, bonding or otherwise permanently affixing the display cover to various portions of the housing and/or display apparatus might present a simplistic solution to such support issues, a permanent affixing of the display cover can present a disadvantageous situation with respect to the display cover not being removable. Having a firmly secured and supported yet readily removable display cover is desirable for several reasons. For example, users may wish to be able to remove the display cover to clean its obverse face, such as where spills, cigarette smoke or other pollutants may have seeped into the device and stained or clouded the back or obverse side of the cover glass. In addition, a user may wish to replace or service the actual display assembly and/or various other components internal to the computer housing. Access thereto can be greatly enhanced, particularly where the computer housing defines a singular integrated unit having the opening for the display cover as its only large access opening. Thus, a removable display cover may be preferable.

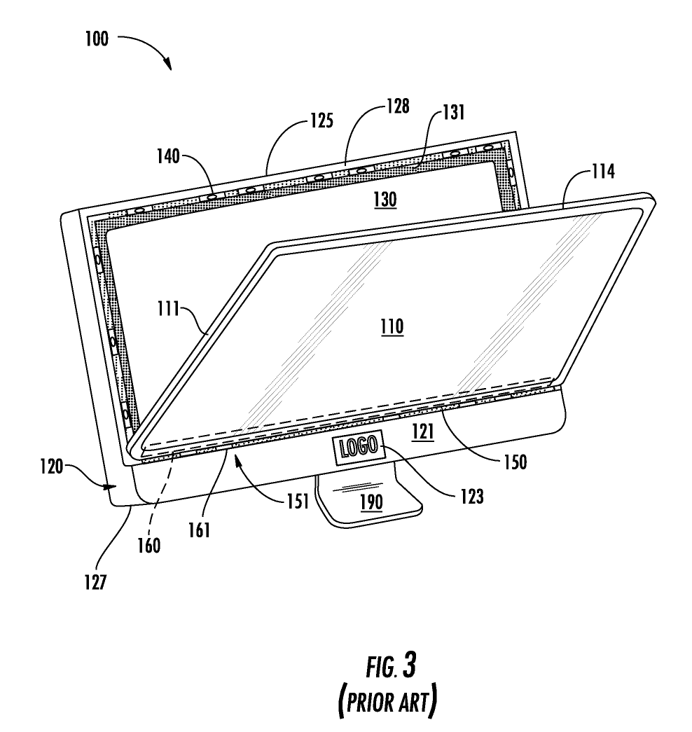

Moving next to FIG. 3, the exemplary computing device of FIGS. 1 and 2 with its display cover 110 partially removed is shown in front elevation view. With the display cover 110 removed from computing device 100, the internal display screen 130 and its associated display device chassis or assembly 131 are exposed to the outside the device via its front. Base member 121 remains at a set forward position with respect to the remainder of computer housing 120. The front facing distal edges 128 of side walls 124 and top wall 125 of computer housing 120 are visible from the front of computing device 100 with the display cover removed. As will be appreciated, particularly with respect to FIG. 1, the display cover 110 fronts and obscures these front distal edges 128 of side walls 124 and top wall 125 when the display cover is installed, such that these edges only become exposed when the display cover is removed. In fact, these front distal edges 128 are preferably not even visible in one embodiment when the display cover 110 is installed, due to a masking layer disposed on or about the display cover, as set forth in greater detail below.

Various support components can be used to secure and support the display cover 110 while it is installed. For example, magnets 140 can be disposed on or about the computer housing 120 and/or display device assembly 131, which magnets can be used to attract one or more metallic items disposed within or on the display cover 110 to hold the display cover in place. As shown in FIG. 3, eight magnets 140 may be positioned along a top edge of the display device assembly 131, while three magnets 140 may be positioned along both of the left and right sides of the display device assembly. Of course, a different number and/or size of magnets can be placed in any particular region, as may be desired. It is thought that having a greater number of magnets across the top may be desirable, as this is where it can be advantageous to have a greater attraction force with the display cover to prevent the display cover from pivoting along its bottom axis to fall away from the overall device.

Although not shown, such support magnets might also be provided on or about the top of base member 121 to correspond to a bottom edge of the display cover, as may be desired. In addition, or alternatively, a separate stabilizer assembly and associated components can be used to secure the bottom edge of the display cover. A toothed ledge 150 can be provided in order to engage a stabilizer assembly 160, which may be coupled to or integrally formed with the display cover 110. Ledge 150 may be integrally formed as a part of base member 121 and computer housing 120, or the ledge may be affixed or otherwise firmly coupled to the computer housing such that it does not move with respect to the housing. For example, ledge 150 may be affixed to and extend upward from the backside of base member 121, as set forth in greater detail below. Various gaps 151 can be provided within ledge 150 to enable engagement with the stabilizer assembly 160 associated with the display cover 110 when it is installed. In particular, the stabilizer assembly 160 can have a number of downward descending hooks 161 or other similar components configured to engage the gaps 151 in the ledge 150. As will be readily appreciated, lateral or side-to-side motion of the display cover 110 with respect to computer housing 120 can be restricted when one or more items coupled to the display cover, such as hooks 161 of the stabilizer assembly 160, are inserted into gaps 151 in ledge 150.

In order to mask or hide the various components coupled to the display cover 110, a masking layer 114 (see, e.g., FIGS. 1 and 3) may be provided on the display cover itself. The masking layer 114 can be a black or otherwise opaque ink that is printed or otherwise disposed onto the obverse face of the display cover 110 in the general shape of an outer frame. Of course, other items besides ink may be used for such a masking purpose. Alternative arrangements can include a masking layer that is separate from the cover glass itself, although such arrangements can be inferior or more cumbersome than a simple printed ink layer. Masking layer 114 can be formed on the front or back of the display cover 110 such that an opaque band is formed along some or all edges of the display cover. For example, a one to two inch wide black ink band from the edge inward and disposed around the entire circumference of obverse face display cover 110 may be suitable to hide or mask the magnets 140, stabilizer assembly 160 and any potentially visible portions of display screen assembly 131 that are not the actual display screen 130. Of course, other dimensions are also possible, and such a masking layer can be less than one inch or greater than two inches wide, as may be desired. In addition to hiding or masking any such unattractive items, masking layer 114 can provide an aesthetically pleasing “frame” or viewing portion through which much or the entire display screen 130 is visible.

As noted above, the front facing distal edges 128 of side walls 124 and top wall 125 of computer housing 120 abut the obverse face of display cover 110 proximate its outer edge, and the distal edge portion 111 abuts the base member 121. Accordingly, the tolerances for these items must be relatively tightly controlled in order to provide a close fit therebetween to achieve the above-described pleasing aesthetic effects. For example, improper tolerances at the distal edges 128 of the side walls 124 and/or top wall 125 of the computer housing 120 may result in the formation of gaps between the display cover 110 and the computer housing when the display cover is attached thereto. Although the resulting gaps may be relatively small, light seepage may occur between the display cover 110 and the computer housing 120 at the distal edges 128 of the side walls 124 and/or the top wall 125. Accordingly, a gap that may not be noticeable when the display screen 130 is turned off may appear relatively large during operation due to light escaping there through.

During the manufacture of the computer housing 120, the computer housing may initially be produced with dimensions differing from specified dimensions. For example, the computer housing 120 may be produced via computer numerical control (CNC) cutting, milling, etc., which may not perfectly produce the computer housing in accordance with the desired specifications in all instances. Further, the dimensions of the computer housing 120 may change from the specified dimensions during handling, shipping, etc. due to forces applied thereto during these processes.

Additionally, the computer housing 120 may be subjected to additional processing after the initial CNC manufacturing process. For example, the base member 121 may be coupled to the computer housing 120 via welding. In some embodiments base member 121 may be subjected to CNC milling or cutting after attachment to the computer housing 120 in order to exactly match the dimensions of the computer housing. Further, the housing 120 may be polished, sandblasted, anodized, and/or subjected to other finishing operations in some embodiments. Applicants have identified that the finishing operations may affect the dimensions of the computer housing 120. In particular, sandblasting may affect the dimensions of the computer housing 120. Thus, the computer housing 120 may not conform to specified dimensions for a variety of reasons, and accordingly, gaps between the computer housing and the display cover 110 may exist, as noted above.

Accordingly, Applicant herein provides methods and systems that may be employed to enhance the fit between the computer housing 120 and the display cover 110. For example, the methods and systems disclosed herein may be configured to adjust the shape and/or dimensions of the computer housing 120. However, as may be understood, the methods and systems disclosed herein may be employed to adjust the shape and/or dimensions of other components to meet desired parameters, and adjustment of the computer housing is provided herein for example purposes only.

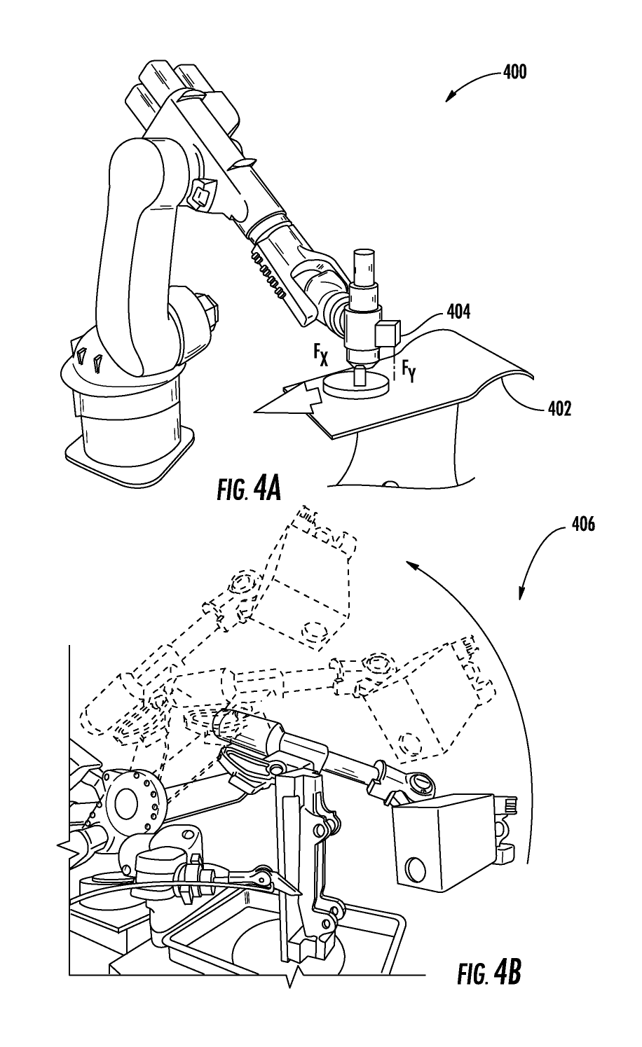

In this regard, FIG. 4A illustrates an example embodiment of a system 400 configured to adjust a shape of a component. By way of example, the system 400 is illustrated as being employed to adjust the shape of the above-described computer housing 120. As illustrated, the computer housing 120 may be received in a corresponding fixture configured to hold the computer housing (and/or other components). Further, the system 400 may include a pre-stress apparatus 402 configured to apply a force to the computer housing 120 in order to apply a force commensurate with elastic deformation of housing 120. In order to determine the initial shape of the computer housing 120, the system 400 may include a measurement apparatus 404 configured to measure a position of a number of points on a portion of the computer housing. By way of example, the measurement apparatus 404 may include one or more laser or optical-based sensors configured to determine the position of points on the computer housing 120. However, various other types of sensors may be employed in other embodiments.

Measuring apparatus 404 can be used to measure points on the surface of housing 120 to generate a point cloud of measured values that characterize a shape of the surface of housing 120. The point cloud of measured values can be compared to a reference point cloud (or reference datum) representing a shape that conforms to a design specification for computer housing 120. In the described embodiment, pre-stress apparatus 402 can take the form of a restrike fixture.

FIG. 4B shows adjustment apparatus 406 in the form of laser 408. In one embodiment, laser 408 can be mobile and housing 120 can remain stationary. In another embodiment, laser 408 can remain stationary and housing 120 can be moved appropriately. In one embodiment, the characteristics of the pre-stress (location, force, and direction of force, etc.) can be predicated upon various factors embodied as a characterization program. The various factors can include, amount of offset, housing material, etc. Moreover, laser 408 can be adjusted based upon the amount of offset and other factors related to housing 120. In any case, laser 408 can be configured to bring the computer housing 120 into compliance with desired specifications. In this regard, the system 400 may adjust the shape of the computer housing 120 at any point during or after manufacture of the computer housing. For example, as noted above, the computer housing 120 may be CNC machined, a base member 121 may be welded to the computer housing and CNC machined, the computer housing may be polished, the computer housing may be sandblasted, and/or the computer housing may be anodized. In one example embodiment, various operations may be performed on the computer housing 120, with the exception of the final anodizing operation, prior to adjustment of the computer housing with the system 400. Accordingly, after adjusting the computer housing 120 (e.g., by bringing any offset into a predetermined range of acceptable values, as will be described below), the computer housing may then be anodized. In this regard, anodizing may not significantly affect the shape of the computer housing 120, and anodizing after adjusting the shape of the computer housing may ensure that the final product includes an anodized finish free of cosmetic defects potentially caused by adjustment.

Further, by coupling the base member 121 to the computer housing 120 prior to applying force to the computer housing, the base member 121 may be brought into conformance with desired specifications. In this regard, Applicants have determined that when the base member 121 is welded to the computer housing 120, the base member may have a tendency to bow inwardly, particularly when welded on three sides as described above. However, by adjusting the shape of the computer housing 120 after the base member is attached thereto, the base member 121 may also be bent into the desired shape due to the coupling therebetween.

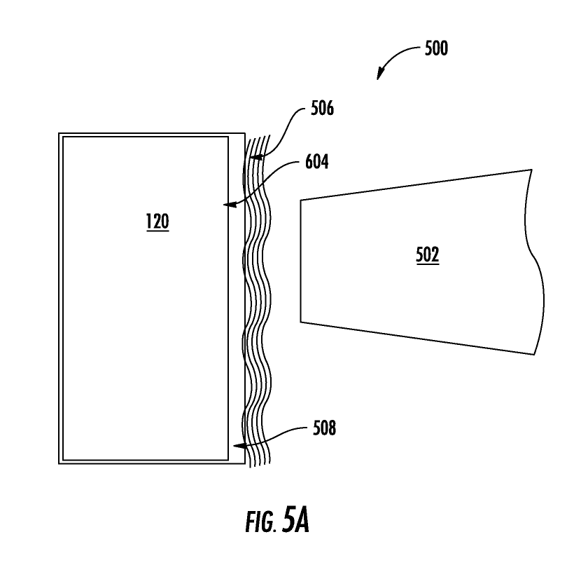

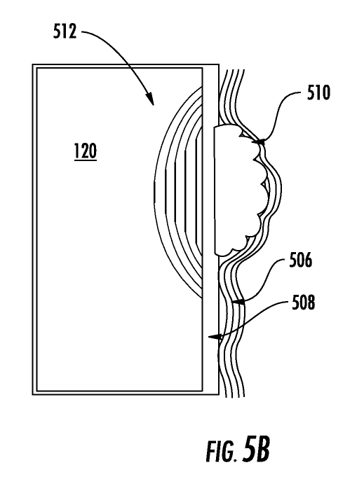

FIG. 5A illustrates a cross sectional view 500 of laser 502 impinging upon surface 504 of housing 120. In the described embodiment, inertial tampering layer 506 (such as water) and ablative layer 508 (in the form of paint or tape) can be used. FIG. 5B shows the effect of laser 502 on surface 504. Laser 502 generates high pressure plasma 510 that results in shockwave 512 that propagates through surface 504 into housing 120 causing a deformation. The amount of deformation can depend upon the characteristics of laser 502 (frequency, pulse duration, intensity, etc.).

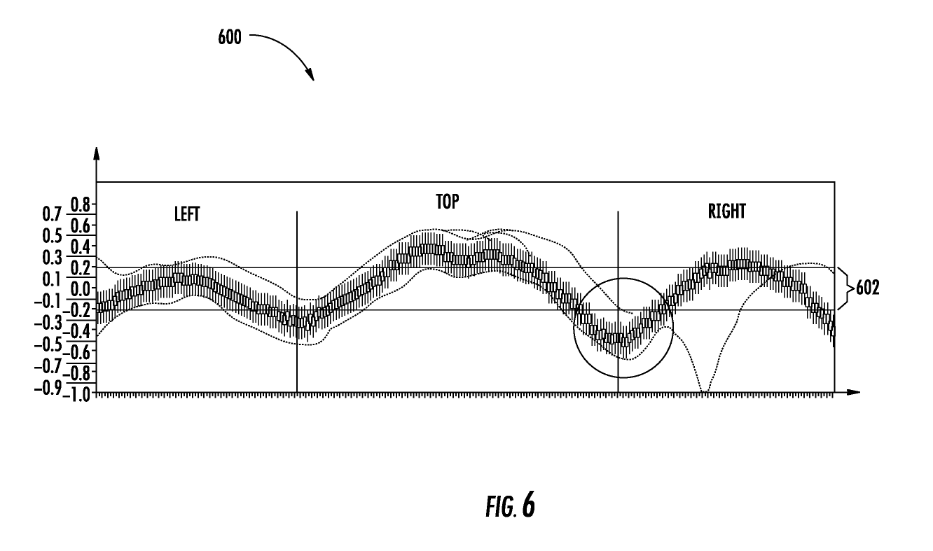

FIG. 6 shows representation of a measured offset values 600 at various locations on surface 120 compared to acceptable range 602 of offset values. Points 604 are shown being those points having corresponding offset values 606 that are determined to be outside of acceptable range 602 and are therefore subject to laser peening in accordance with the described embodiments.

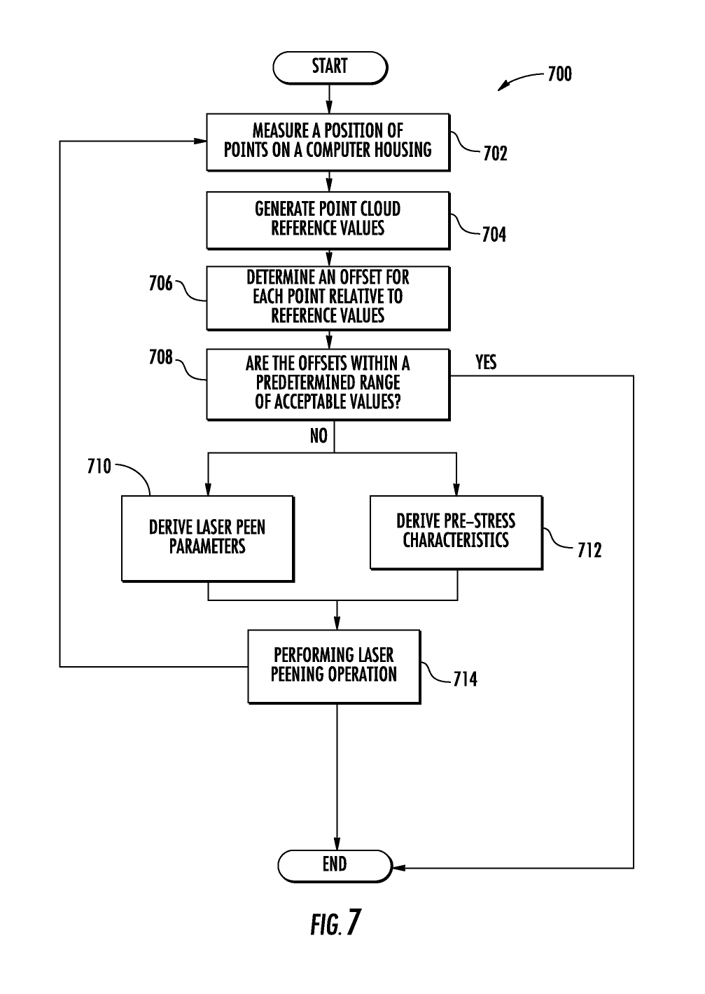

As illustrated in FIG. 7, a related method for adjusting the shape of computer housing is also provided. As illustrated, the method may start at step 700. At step 702, the method may include measuring a position of points on a portion of a computer housing that are used at 704 to provide a point cloud of measured values. Further, the method may include determining an offset between the position and a reference value for each of the points at step 706. The method may also include determining for each point if the associated offset is within an acceptable range of offset values. If the determination is that the offset values are within the acceptable range, then process 700 ends, otherwise at 710 and 712, laser peening parameters and pre-stress characteristics are concurrently obtained. The laser peening operation is performed at 714 and control is passed back to 702 and process 700 repeats until all, or substantially all, of the measured points have an acceptable offset value.

In various embodiments of the method, applying the force at step 714 may include plastically deforming the computer housing. Plastically deforming the computer housing may include inducing a stress up to about 105%, up to about 110%, up to about 115%, up to about 120%, or up to about 125% of a yield stress of the computer housing.

The adjustment apparatus 804 may be configured to apply pre-stress force to facilitate laser peeing operation to bring the computer housing 120 into compliance with desired specifications. In this regard, the system 800 may apply a pre-stress force at computer housing 120 at any point during or after manufacture of the computer housing. For example, as noted above, the computer housing 120 may be CNC machined, a base member 121 may be welded to the computer housing and CNC machined, the computer housing may be polished, the computer housing may be sandblasted, and/or the computer housing may be anodized. In one example embodiment, various operations may be performed on the computer housing 120, with the exception of the final anodizing operation, prior to adjustment of the computer housing with the system 800. Accordingly, after adjusting the computer housing 120 (e.g., by bringing any offset into a predetermined range of acceptable values, as will be described below), the computer housing may then be anodized. In this regard, anodizing may not significantly affect the shape of the computer housing 120, and anodizing after adjusting the shape of the computer housing may ensure that the final product includes an anodized finish free of cosmetic defects potentially caused by adjustment.

In an additional embodiment a non-transitory computer readable medium for storing computer instructions executed by a processor in a controller for controlling a system configured to adjust a shape of computer housing is provided. The non-transitory computer readable medium may include computer code for measuring a position of points on a portion of a computer housing, computer code for determining an offset between the position and a reference value for each of the points, and computer code for applying a force based on the offset with an actuator at each of the points on the portion of the computer housing for an amount of time. The computer code for measuring the position, the computer code for determining the offset, and the computer code for applying the force may be configured to be conducted until the offset is within a predetermined range of acceptable values. Further, the computer code for applying the force may include computer code for determining a displacement distance of the actuator configured to decrease the offset at each of the points. Also, the computer code for applying the force may include computer code for determining the force configured to decrease the offset at each of the points.

Although the systems, assemblies, methods, and non-transitory computer readable medium disclosed herein have generally been described in terms of adjusting computer housings, it should be understood that the systems, assemblies, methods, and non-transitory computer readable medium may be employed to adjust the shape of other components of a computer and components that do not define a portion of a computer.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A method for adjusting a shape of computer housing, comprising:
measuring a position of a plurality of points on a portion of the computer housing;
determining an offset between the position and a reference value for each of the points; and
comparing the offset at each of the points to a range of offset values corresponding to each point;
using a laser to apply a force only at those points having offset values outside of the range of offset values for an amount of time,
wherein measuring the position, determining the offset, and applying the force are conducted until the offset is within a predetermined range of acceptable values; and
repeating the comparing and using the laser until substantially all offsets are within their respective ranges of offset values.

2. The method of claim 1, wherein the laser generated force comprises plastically deforms the computer housing.

3. The method of claim 1, wherein applying the force based on the offset comprises determining laser pulse width and laser energy configured to decrease the offset at each of the points to value within the respective range of offset values.

4. The method of claim 1, further comprising inserting the computer housing in a fixture.

5. A system configured to adjust a shape of computer housing, the apparatus comprising:
a measurement apparatus configured to measure a position of a plurality of points on a portion of the computer housing;
a determining apparatus configured to determine an offset between the position and a reference value for each of the points; and
a laser adjustment apparatus configured to apply a laser beam at a surface other computer housing, the laser beam generating a force having a magnitude and direction based on the offset at each of the points on the portion of the computer housing for an amount of time,
wherein the measurement apparatus, the determining apparatus, and the adjustment apparatus are respectively configured to measure the position, determine the offset, and repeat the laser adjusting until the offset is within a predetermined range of acceptable values.

6. The system of claim 5, further comprising a fixture configured to hold the computer housing.

7. The system of claim 6, wherein the measurement apparatus comprises a measuring laser.

8. The system of claim 6, further comprising an alignment member, wherein the adjustment apparatus is configured to compress the computer housing against the alignment member, and the measurement apparatus is configured to measure the position of the points on the portion of the computer housing through the alignment member.

9. The system of claim 6, wherein the alignment member comprises glass.

10. Non-transitory computer readable medium for storing computer code executable by a processor for adjusting a shape of a computer housing, the computer readable medium comprising computer code for:
measuring a position of a plurality of points on a portion of the computer housing, determining an offset between the position and a reference value for each of the points, comparing the offset at each of the points to a range of offset values corresponding to each point, using a laser to apply a force only at those points having offset values outside of the range of offset values for an amount of time, wherein measuring the position, determining the offset, and applying the force are conducted until the offset is within a predetermined range of acceptable values, and repeating the comparing and using the laser until substantially all offsets are within their respective ranges of offset values.

11. The non-transitory computer readable medium of claim 10, wherein the laser generated force comprises plastically deforms the computer housing.

12. The non-transitory computer readable medium of claim 10, wherein applying the force based on the offset comprises determining a laser pulse width and laser energy configured to decrease the offset at each of the points to value within the respective range of offset values.

13. The non-transitory computer readable medium of claim 10, further comprising computer code for inserting the computer housing in a fixture.

14. A method of modifying a shape of an enclosure, comprising:
obtaining a set of measured values at selected points of the enclosure;
obtaining a set of offset values at at least some of the selected points based upon the set of measured values;
adjusting a parameter of a laser in accordance with the set of offset values;
obtaining a set of mechanical pre-stress characteristics used to pre-stress the enclosure at selected pre-stress points; and
modifying the shape of the enclosure by applying a mechanical stress at the selected pre-stress points in accordance with the pre-stress characteristics, and applying the laser at pre-determined points in accordance with the laser parameter, wherein the modifying is carried out until most of the offset values are within a pre-determined range of acceptable offset values.

15. The method of claim 14, wherein the laser generates a force at the enclosure, wherein the laser generated force plastically deforms the enclosure.

16. The method of claim 15, wherein the laser force is based on the set of offset values, wherein the set of offset values determines laser pulse width and laser energy configured to decrease the offset at each of the points to value within the pre-determined range of acceptable offset values.

17. The method of claim 16, wherein the enclosure is inserted into a fixture prior to obtaining the set of measured values.

18. The method of claim 14, wherein the set of offset values are determined based upon a difference between the set of measured values and corresponding reference values, the reference values comprising a point cloud of data that corresponds to a reference shape.

19. The method as recited in claim 18, wherein the laser is a laser beam having a pulse width of about 25 ns, a power of about 25 Joules, and a wavelength of about 1 micron.

20. The method as recited in claim 19, the enclosure further comprising a surface ablative layer and an inertial damping layer disposed adjacent to the surface ablative layer each located at the point at which the laser beam impinges the surface of the enclosure.

21. The method as recited in claim 20, wherein the laser beam interacts with the surface ablative layer and the inertial damping layer to create a high pressure plasma at the surface of the enclosure.

22. The method as recited in claim 21, wherein the high pressure plasma creates a shock wave that propagates through the enclosure.

23. The method as recited in claim 22, wherein the shock wave deforms the enclosure that has been previously plastically deformed by the applied pre-stress, the shock wave deformation permanently re-shaping the enclosure that reduces a corresponding offset value.
